(19) United States
(12) Patent Application Publication
(10) Pub. No.: US 2007/0005899 A1
(43) Pub. Date: Jan. 4, 2007

(54) Processing multicore evictions in a CMP multiprocessor

(76) Inventors: Krishnakanth V. Sistla, Hillsboro, OR (US); Yen-Cheng Liu, Portland, OR (US); Zhong-Ning Cai, Lake Oswego, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/173,919

(22) Filed: Jun. 30, 2005

(51) Int. Cl. G06F 12/00; G06F 13/28

(52) U.S. Cl. 711/134; 711/146

(57) ABSTRACT

A method and apparatus for improving snooping performance is disclosed. One embodiment provides mechanisms for processing multi-core evictions in a multi-core inclusive shared cache processor. By using parallel eviction state machine, the latency of eviction processing is minimized. Another embodiment provides mechanisms for processing multi-core evictions in a multi-core inclusive shared cache processor in the presence of external conflicts.

### BACKGROUND INFORMATION

Multi-core processors contain multiple processor cores which are connected to an on-die shared cache though a shared cache scheduler and coherence controller. Multi-core multi-processor systems are becoming increasingly popular in commercial server systems because of their improved scalability and modular design. The coherence controller and the shared cache may either be centralized or distributed among the cores depending on the number of cores in the processor design. The shared cache is usually designed as an inclusive cache to provide good snoop filtering.

When a line is evicted from the shared cache for capacity reasons, to maintain the inclusive property, a un-core control logic needs to ensure that the line is removed from the corresponding core caches. A need exists for ordering logic that may be adopted in the un-core control logic for processing evictions to lines that are shared by more than one core

Additionally, conflict resolution mechanisms may be needed to resolve multiple transactions to the same address. In particular, conflicts between multi-core evictions and system snoops. Thus a need also exists for conflict resolution techniques that may be used in uncore control logic such that snoop and data traffic to the core caches may be minimized while handling snoop and evictions conflicts.

### BRIEF DESCRIPTION OF THE DRAWINGS

Various features of the invention will be apparent from the following description of preferred embodiments as illustrated in the accompanying drawings, in which like reference numerals generally refer to the same parts throughout the drawings. The drawings are not necessarily to scale, the emphasis instead being placed upon illustrating the principles of the inventions.

FIG. 1a is a block diagram of a MCMP system with a caching bridge, according to one embodiment.

FIG. 1b is a block diagram of a distributed shared cache, according to one embodiment.

FIG. 2 is a logic state diagram for processing multi-core evictions, according to one embodiment.

FIG. 3 is a logic state diagram of a sub-state machine for processing multi-core evictions, according to one embodiment.

FIG. 4 is a diagram of a conflict window for snoop and multi-core evictions conflicts.

FIG. 5 is a logic state diagram for processing multi-core evictions of FIG. 2 with snoop conflict, according to one embodiment.

FIG. 6 is a logic state diagram of snoop management, according to one embodiment.

FIG. 7 is a block diagram of an alternative system that may provide an environment for multithreaded processors supporting multi-core evictions.

### DETAILED DESCRIPTION

The following description describes techniques for improved multi-core evictions in a multi-core processor. In the following description, numerous specific details such as logic implementations, software module allocation, bus and other interface signaling techniques, and details of operation are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner in one or more embodiments.

In certain embodiments the invention is disclosed in the form caching bridges present in implementations of multi-core Pentium® compatible processor such as those produced by Intel® Corporation. However, the invention may be practiced in the cache-coherency schemes present in other kinds of multi-core processors, such as an Itanium® Processor Family compatible processor or an X-Scale® family compatible processor.

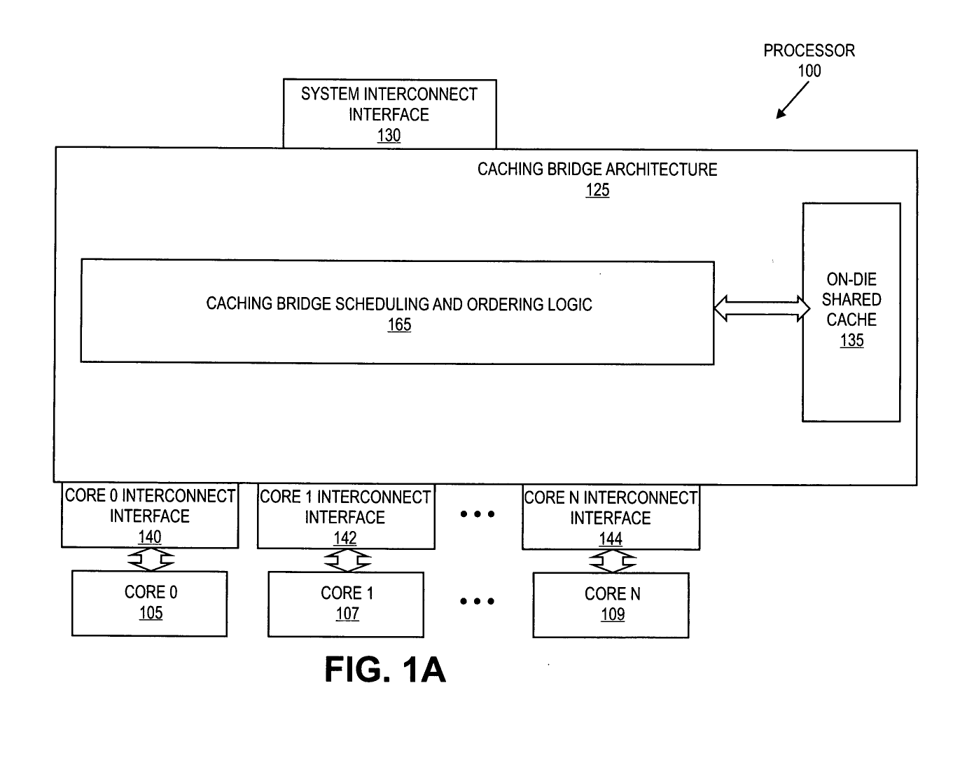

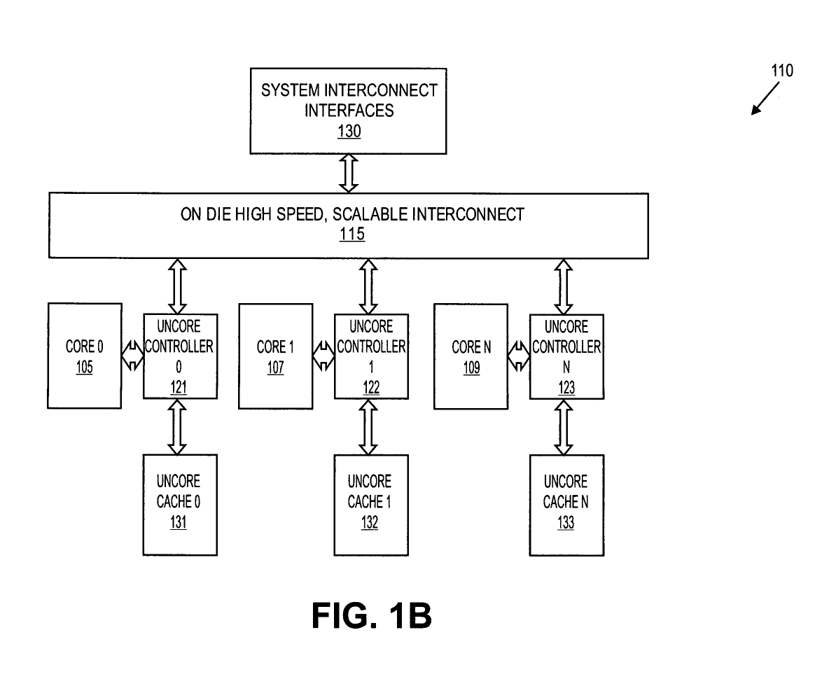

Referring now to FIG. 1a, a block diagram of a processor 100 including a bridge and multiple cores is shown, according to one embodiment. Processor 100 may have N processor cores, with core 0 105, core 1 107, and core n 109 shown. Here N may be any number. Each core may be connected to a bridge as shown using interconnections, with core 0 interconnect interface 140, core 1 interconnect interface 142, and core n interconnect interface 144 shown. In one embodiment, each core interconnect interface may be a standard front-side bus (FSB) with only two agents, the bridge and the respective core, implemented. In other embodiments, other forms of interconnect interface could be used such as dedicated point-to-point interfaces.

Caching bridge 125 may connect with the processor cores as discussed above, but may also connect with system components external to processor 100 via a system interconnect interface 130. In one embodiment the system interconnect interface 130 may be a FSB. However, in other embodiments the system interconnect interface 130 may be a dedicated point-to-point interface.

Processor 100 may in one embodiment include an on-die shared cache 135. This cache may be a last-level cache (LLC), which is named for the situation in which the LLC is the cache in processor 100 that is closest to system memory (not shown) accessed via system interconnect interface 130. In other embodiments, the cache shown attached to a bridge may be of another order in a cache-coherency scheme.

Scheduler 165 may be responsible for the cache-coherency of LLC 135. When one of the cores, such as core 0 105, requests a particular cache line, it may issue a core request up to the scheduler 165 of bridge 125. The scheduler 165 may then issue a cross-snoop when needed to one or more of the other cores, such as core 1 107. In some embodiments the cross-snoops may have to be issued to all other cores. In some embodiments, they may implement portions of a directory-based coherency scheme (e.g. core bits). The scheduler 165 may know which of the cores have a particular cache line in their caches. In these cases, the scheduler 165 may need only send a cross-snoop to the indicated core or cores.

Referring now to FIG. 1b, a diagram of a processor with a distributed shared cache, according to one embodiment. In this processor 110, the shared cache and coherency control logic is distributed among the multiple cores. In particular, each core 105, 107, 109 is connected to the other uncore caches 131, 132, 133 through it's uncore controllers 121, 122, 123. The cache is broken up into n components, but logically behaves as one single cache. Each core may access the other caches through the uncore controller and interconnect. It is immaterial how the caches is designed, as long as, there are multiple cores and the cache is an inclusive, unified shared cache. By uncore, it means everything beyond the core interface. The eviction method described herein occurs in the uncore controller.

The scalable high speed on-die interconnect 115 may ensure that the distributed shared cache accesses have a low latency. There exists a latency and scalability tradeoff between both the configurations of FIGS. 1a and 1b. The caching bridge architecture of FIG. 1a may provide a low latency access to the shared cache when the number of cores is relatively small (2 to 4). As the number of cores increases, the bridge 165 may become a performance bottleneck. The distributed shared configuration of FIG. 1b may provide a scalable but relatively higher latency access to the shared cache 135.

Multi processor systems may slow down the core pipelines by the large amount of snoop traffic on the system interconnect. The CMP shared cache may be designed as fully inclusive to provide efficient snoop filtering. To maintain the inclusive property the bridge logic needs to ensure that whenever a line is evicted from the shared cache back snoop transactions are sent to the cores to remove the line from the core caches. Similarly all lines filled into the core caches are filled in to the LLC. The uncore control logic may sequence these back snoop transactions to the all core caches which contain the corresponding cache line. Eviction processing for lines which are shared between multiple cores may be made efficient by using the presence vector information stored in the inclusive shared cache. The proposed solution discusses a multi-core eviction processing scheme that may be used either in a single shared cache or a distributed shared cache configuration.

Additionally, the proposed embodiments may also need to handle any conflicts with system snoops and core requests while the inclusive actions are in progress. This conflict handling mechanism may need to preserve coherency while avoiding data corruption. The mechanism may also need to be optimized so as not to issue unnecessary snoops to the cores in the processor. Thus, another proposed embodiment proposes a snoop-eviction handoff mechanism to efficiently handle conflicts between snoops and multi-core evictions.

Initially, a coherence actions begin when the uncore control logic determines that a capacity eviction may need to occur for a new line which is being filled into the shared cache. Any time an eviction occurs in the inclusive cache, due to a fill, all the core caches have to be invalidated. A fill into the LLC detects an eviction, since an eviction is required to do a fill.

The shared cache may optionally store information on which cores in the processors have accessed this line. This presence vector may be copied into the uncore control logic along with the physical address of the evicted line on seeing an eviction from the cache. The cache line is also copied into a data buffer which is logically tied to the current eviction. In the absence of presence vector information from the shared cache (which can be the case if the cache is optimizing tag size), the presence vector may be initialized to all ‘ones’ indicating the worst can scenario of all cores sharing the line.

Based on the coherency state of the line being evicted and its core bit information, the eviction processing agent may make a prediction as to which core to snoop and when the back snoop operation is complete. The eviction processing is complete when all the back snoops have been sent to the core caches. It is imperative that the inclusive nature of the shared cache be taken advantage of to optimize the number of back snoops which are issued from the shared cache. By differentiating the behavior of single core evictions from multiple core evictions the multi-core eviction processing may be optimized

Shared cache fills are caused by accesses from cores which have missed the inclusive shared cache. Depending on the occupancy of the cache set capacity evictions can occur due this fill. From the view point of the cache control logic, it injects a fill into the shared cache and after a fixed delay it observes that an eviction has occurred in the cache pipeline. It is now the responsibility of the cache control logic to ensure that this eviction is processed and inclusion is maintained.

The proposed eviction management logic embodiment enters the IDLE state on observing an eviction from the inclusive shared cache. When a line is evicted from the shared cache, it is expected that the cache passes on the coherence state, presence vector (core bits) and the cache line data to the cache control logic. The eviction management logic receives this information and processes multi-core evictions

It should be noted that the sequencing logic for this embodiment is based on the following two observations.

First, if exactly one core cache contains the line, the line could possibly be in modified state in this core's cache. This implies the possibility of a data transfer (HITM) from the core cache to the un-core, which eventually needs to written out to the system memory.

Secondly, if more than one core cache contains the line then the highest coherence state in the core caches is shared. This implies that there is no possibility of a data transfer (HITM) from any of the core caches which contain this line. Since this is known in advance, data transfers need not be scheduled for these cases

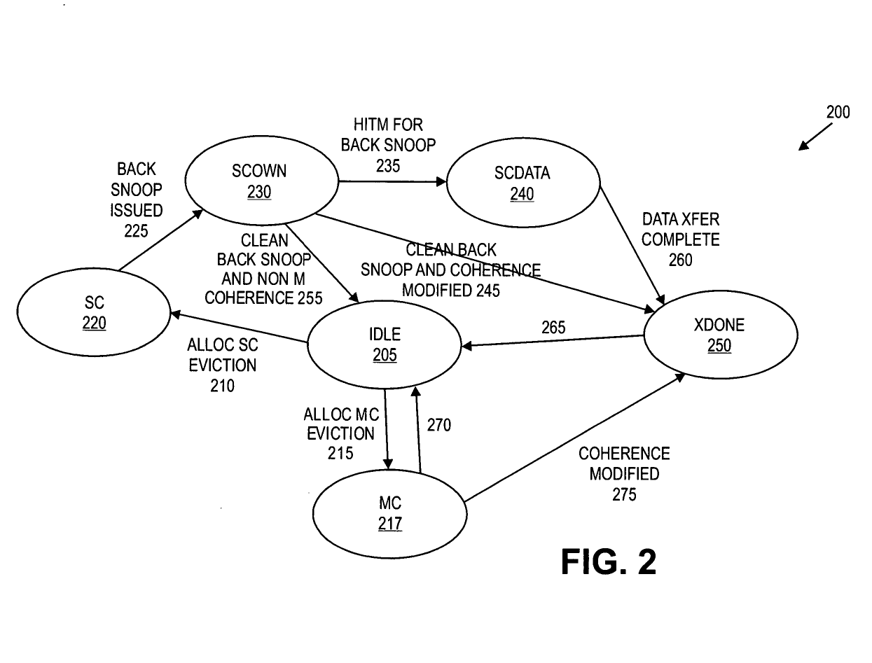

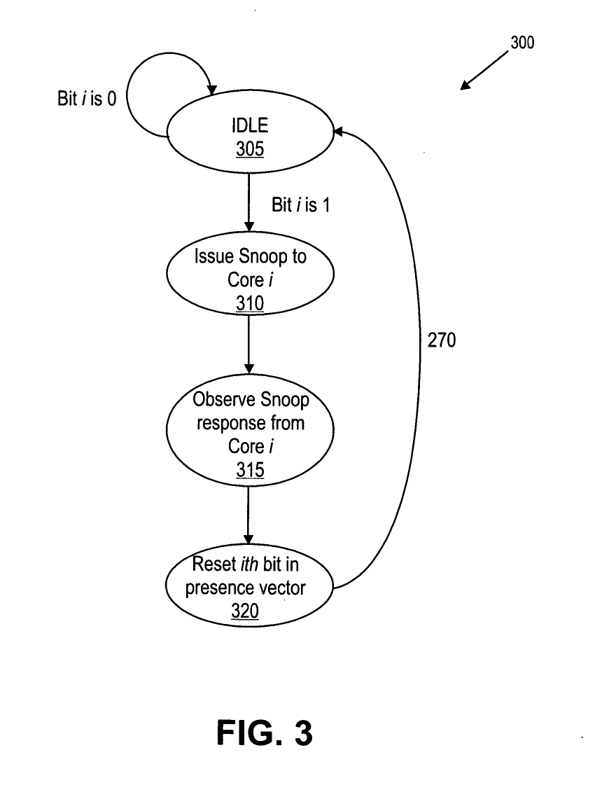

Now referring to FIG. 3, a logic state diagram 200 for eviction management is shown, according to one embodiment. Eviction management logic is responsible for tracking the progress of inclusion back snoops. There is a fundamental difference between how “single core” evictions (exactly one presence bit set) and “multi core” (more than one presence bit set) evictions are handled. For each eviction from the shared cache the embodiment of FIG. 2 is initialized. Each entry contains the address, presence vector, shared cache coherence state, data buffer pointer, SC eviction bit and data valid bit. The presence vector is ‘n’ bit wide for a ‘n’ core processor. The size of other fields is decided by the exact implementation details.

Initially, the state machine 200 is idle 205. Upon detecting that there is an eviction in the LLC, the eviction management logic is triggered. First, the state machine 200 needs to determine if it is a single or multi-core eviction. Single eviction means the line being evicted is contained in only one core cache. Multicore eviction means the line being evicted is contained in more than one core cache. If the eviction is in one core cache, then the line may be modified. However, if the line is present in more than one core cache, then it cannot be modified. A single core eviction is essentially where the presence vector notifies the machine that exactly one core contains this line and hence the plausibility of modified data exists. A multi-core eviction is where the presence vector/core bits tells you that more than one core contains this line and thus modified data does not exist.

The processor knows if its one core or multi-core based on the presence vector. The core bit is a vector, where if the ith bit is set, it indicates that core i has the cache line. If more than one bit is set then it is a multiple core eviction. Not modified may indicate not modified in the cores, it could be modified in the cache or LLC.

Prior to the state machine entering idle, there is a point in the pipeline that the cache is returning, entry point, before the state machine has to be initialized to some value. Upon entering the idle state, the machine may first set the data valid bit to 1 to indicate, for this line, if there is any data stored in the data buffer. Because it's an eviction, the cache will always supply data to the machine if indicated. The controller may need to know if the machine has the most recent data. At the beginning of an eviction, the controller assumes it has valid data. Secondly, if there is no core bit information in the cache, the presence vector field is initialized to all 1s. Third, once the data from the cache is obtained, it is stored in a data buffer. Next, if the presence vector has exactly 1 bit set, then the single core evict bit is set, otherwise, reset its. Fifth, copies the coherence from the cache to the coherence state field. Finally, determines which cores have issued the eviction message. This is determined by looking at the issue vector. If the issue vector bit is set then the controller has managed to issue the eviction transaction to that particular core.

Upon completion of the above steps, the machine looks at the single core evict bit, where it is a single or multi-core eviction. If the bit is set to 1, then a state transition 210 occurs to a single core state 220. If the bit is set to 0, then a state transition 215 occurs to a multicore state 217.

If it's a single core eviction 220, a back snoop message is composed and issued 225 to the core interface 140, 142, 144. The core which is pointed by the presence vector has now received the eviction message. Once the owning core has received the eviction message, the state transitions to SCOWN 230.

In SCOWN state 230, the SC eviction message is now owned by the core. The machine will wait till the snoop response is observed from the core to which the back snoop is issued. The machine is waiting for a message to indicate that the owning core has acted upon the eviction message. Because the data is owned by one core, the data could have been modified.

The core may come back with a “HITM” or “CLEAN” response. If the snoop response from the core is a “HITM” 235, then the state transitions to SCDATA 240 to obtain new data from the core. The coherence state is updated to indicate modified state. The system now knows that any data in the data buffer is stale data. The core will supply a more recent copy of the data during the data phase. Data valid bit is now reset.

If the snoop response from the core is “CLEAN”, and the coherence state is one of M, MI or MS the machine transitions 245 to XDONE 250. This indicates that the data in the data buffer is the most recent and may be written to the system memory. However, if the snoop response from the core is “CLEAN” and the coherence state is one of E, S or ES, the machine transitions 255 to IDLE 205 and de-allocates the entry. This indicates that the inclusion actions of the back snoop are complete and there is no need to update system memory.

In the SCDATA state 240, the machine is waiting for the core to send the modified data. Once all the data is transferred to the data buffer, the machine transition 260 to XDONE 250 and sets the data valid bit to 1.

In the XDONE state 250, the transaction is waiting to write the modified data to the memory agent. All the core caches are clean, the controller has the latest data and the controller knows it has the modified data. During XDONE state 250, the machine is writing data back to memory. Once main memory is updated, the controller transitions 265 to IDLE 205.

Now referring to FIG. 3, a logic state diagram for a sub-state machine is shown, according to one embodiment. These state machines work in parallel since the core interfaces are independent of each other. The ith state machine is shown in FIG. 3.

If the single core evict bit is set to 0, then a state transition 215 occurs to a multi-core state 217. The MC state 217 has various sub-state machines and it is the wait state for completing evictions to all the cores. The issue vector contains is a list of cores that need to be updated or activated. The ith state machine looks at the ith bit. If the ith bit is set, then a snoop for that core needs to be issued. The machine may compose the snoop (build the eviction message).

The state machines 300 work in parallel since the core interfaces are independent of each other. All the state machines are looking at the issue vector. Based on the bits set in the issue vector, they will generate an eviction message and issue them in parallel to the core interfaces.

In FIG. 3, initially bit i is equal to 0 and in IDLE, 305. Back snoops are issued to the ith core interface 310, if the ith bit is set in the presence vector. If the back snoop is successfully issued on the ith core, set the ith bit in the issue vector. If the snoop result, which is always clean, is observed from the ith core 315 and the ith bit in the issue vector is set, reset the ith bit in the presence vector 320 indicating that the back snoop to this core is observed globally. The snoop response from the cores is clean because the core has no modified data.

Once the presence vector is all zeros and the coherence state is one of E, ES or S, change the state to IDLE 270. When the presence vector is all zeros and the coherence state is one of M or MS, change the state to XDONE 275.

Advantageously, the embodiments described above present mechanisms for processing multi-core evictions in a multi-core inclusive shared cache processor. By using parallel eviction state machine, the latency of eviction processing may be minimized. By using the presence vector information, the total number of back snoops issued is optimized.

In another embodiment, the problem of a system snoop conflicting with the multi core eviction in progress presents a unique bandwidth and latency tradeoff. For memory ordering reasons the system snoop cannot be allowed to return until all the back snoop operations are complete. This however is a long latency operation. On the other hand, if the system snoop is allowed to send snoops to all core caches without regard to the current multi core eviction in progress, the number of snoops issued for the line will be doubled, thus wasting the core interface bandwidth.

It should be noted that the sequencing logic for this embodiment is based on the following two observations.

First, a new data structure is added to the multi-core evictions engine to keep track of the number of back snoops issued at any instant. This is a bit vector of width “n”, where is n is the number of cores. On detecting a conflict this structure is passed from the eviction processing engine to the snoop processing engine, letting the snoop processing engine to issue only snoops which are not yet issued. This choice will not only reduce the number of snoops sent to the core caches, it will also reduce the average snoop latency.

Secondly, upon detecting a conflict, eviction processing engine may pass the current presence vector, data buffer id, eviction state, coherence state to the snoop processing engine. The snoop processing engine will optimize its behavior based on this information.

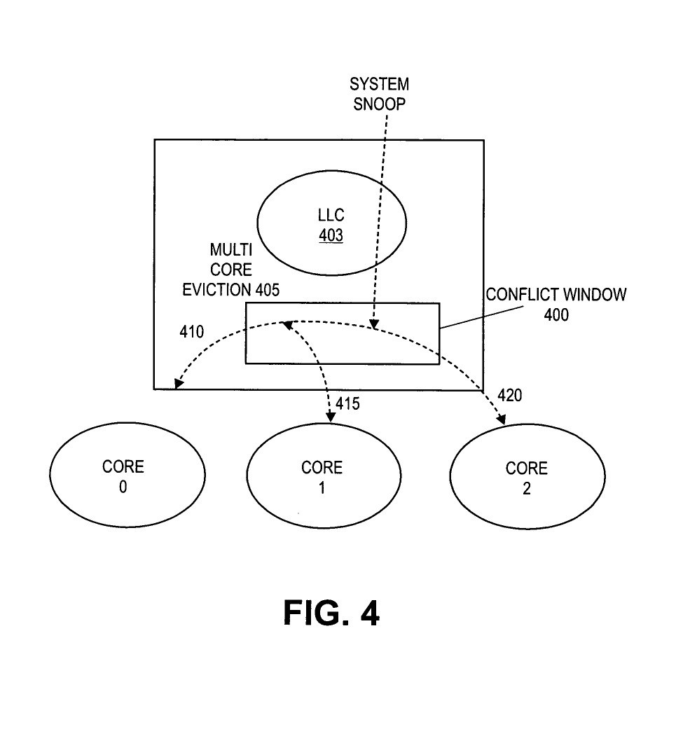

FIG. 4 illustrates a diagram of the conflict window between a multi-core eviction and a system snoop. Depending on the state in which the conflict is detected, different actions need to be taken to ensure correctness and optimal snoop bandwidth usage. This embodiment proposes mechanisms used to detect such a conflict, actions taken by the eviction processing on detecting the conflict and the actions taken by the snoop processing on detecting this conflict.

There are at least two instances that may cause conflicts with multi core evictions. They are snoops and write back from the cores. In a multi core eviction the machine knows there is no data coming back to the cores. This information is used to determine which cores to send the snoops and which cores not to send snoops. The machine wants to control the number of snoops going to the cores because it affects performance of the overall system.

Now referring to FIG. 4, a conflict window 400 between a multi-core eviction and a system snoop is shown. From when a multi core eviction is issued 405 from the LLC, the conflict window 400 indicates the process of sending snoops to the cores and getting them back. The window from which the eviction occurs to the point snoops are collected is the time within which a conflict may occur.

In one instance 410, the conflict window occurs when no snoops have been issued to the cores. In a second instance 415, the conflict window occurs where snoop has been issued, obtained a response back, but nothing had been done with the received response. Finally, in a third instance 420, managed the snoop, but have not received anything back from the cores. For any of these states where you issued a snoop, received a response but have not processed it yet, it is considered a conflict window 400.

In addition to the two observations stated above, there are three components to the proposed solution: a conflict detection logic, an enhanced eviction management logic and a snoop management logic.

In the conflict detection logic the snoop processing engine issues a snoop probe to the eviction processing logic in parallel with the shared cache lookup. Throughout this specification, this action may now be referred to as a “snoop probe”. The eviction processing engine will match the address with all evictions in flight and indicate a hit to the snoop engine if there is a match. The snoop may have a hit either the shared cache or the eviction engine but not both. This is because the line may be either an eviction or it is present in the last level shared cache. A hit for the snoop probe indicates that a conflict has been detected.

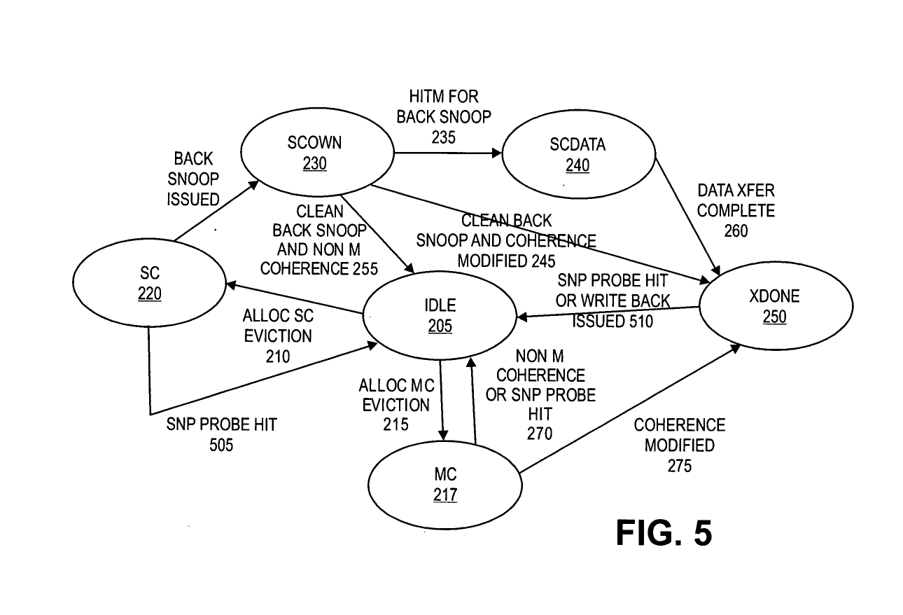

Referring now to FIG. 5, a logic state diagram of the eviction management logic of FIG. 2 with snoop conflict. The eviction management logic 200 is enhanced by adding an issue vector to the eviction processing engine. New actions are defined for eviction processing engine based on the current state. The issue vector is updated to indicate the cores to which snoops have been issued so far. For example, the 2^{nd} bit is set if a snoop has been issued to core with id 2. The remaining data structures remain the same as discussed earlier with respect to FIG. 2.

From Idle 205, if a snoop probe hits the eviction in the single core state, the data buffer id, coherence state, presence vector, issue vector, data valid bit and the single core bit is passed back to the snoop management logic 505. It is passed back to the IDLE state because in the single core state the machine has not issued the back snoop, it has only determined that there was an eviction. From XDONE state 250, the machine will transition to IDLE 205 when it has finished processing the eviction message 510. The ownership of the line is now transferred to the snoop.

If the snoop hits a multi-core eviction (SC bit not set) 215, then it picks up the presence vector and the issue vector and the multi-core eviction is immediately de-allocated.

For the snoop management logic, the state machine integrates the snoop behavior based on the snoop probe behavior. The total amount of snoops issued to the cores is optimized. The snoop management logic is responsible for ensuring that coherence state of the inclusive shared cache and the core caches is modified appropriately with respect to the external agents. To preserve coherency this logic observes multi core evictions which are currently being processed. Snoop management logic issues a lookup of the eviction management logic in parallel with looking up the inclusive shared cache tag. This lookup is referred to as a “snoop probe”. The effect of snoop probe on different states for multi-core evictions was described above in the specification.

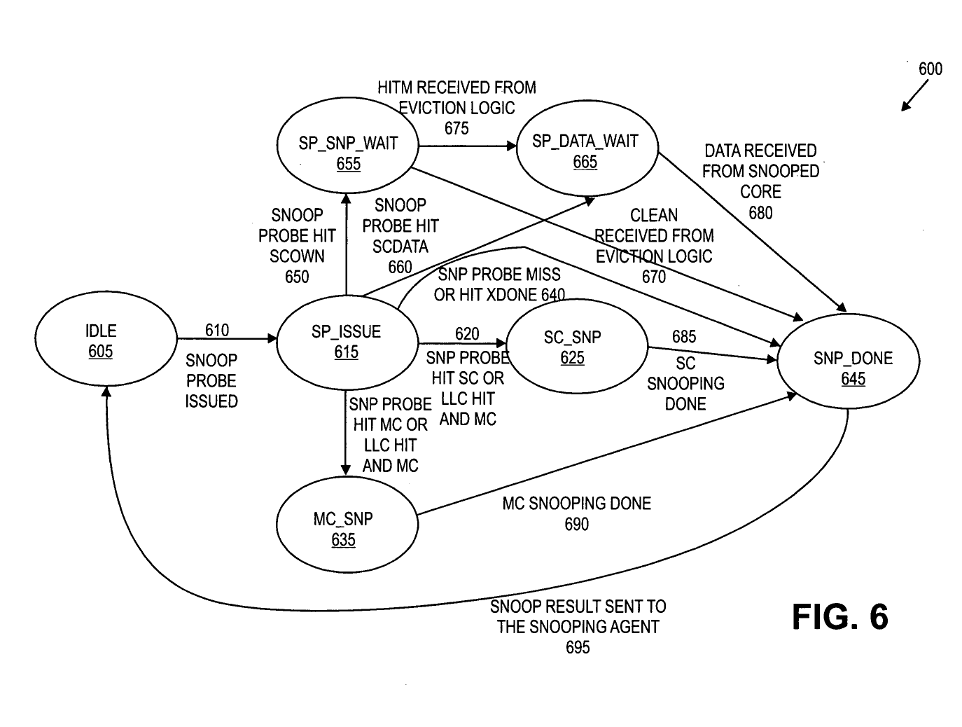

Referring now to FIG. 6, an embodiment of the snoop management logic 600. The state diagram of FIG. 6 illustrates how the snoop is issued to the LLC to when the results of the snoop are returned to the external agents.

During IDLE state 605, the snoop has started looking at the LLC. As it looks at the LLC, a snoop probe is issued 610 with the eviction machine and a shared cache lookup in parallel. On issuing the LLC looking and snoop probe, the state transitions to SP_ISSUE state 615.

During the Sp_ISSUE state 615, the machine will wait for the LLC lookup and snoop probe actions to complete. If the snoop probe hits, receive coherence state, presence vector, issue vector, data valid, and the single core bit from the eviction management logic. If the LLC cache hits, the machine receives the presence vector and coherence state from the cache. However, if both the LLC cache and snoop probe return a miss, the snooping action is complete. Based on the data structures, the machine will now transition to the different states from SP_ISSUE 615.

If the LLC cache hits and the presence vector is exactly one 620, then the state transitions to SC_SNP 625, else the state transitions 630 to MC_SNP 635.

If the LLC cache misses and snoop probe misses 640, snooping action is now complete. The state transitions to SNP_DONE 645. If the snoop hits and eviction logic state is XDONE 640, then also transition to SNP_DONE 645.

If the snoop probe hits and eviction logic state is SCOWN 650, then the state transition to SP_SNP_WAIT 655.

If the snoop probe hits and eviction logic state is SCDATA 660, then the state transition to SP_DATA_WAIT 665.

If the snoop probe hits and eviction logic state is SC 620, then the state transition to SC_SNP 625.

If the snoop probe hits and eviction logic state is MC 630, then the state transitions to MC_SNP 635.

Once the state transitions to SP_DATA_WAIT 665, it waits for the snoop result from the eviction management logic. This state indicates a single core snoop has already been issued by the eviction management logic. To conserve bandwidth, the snooping logic waits for this snoop to complete.

If the snoop results from the eviction management logic is clean 670, the state transitions to SNP_DONE 645. However, if the snoop results from the eviction management logic is “HITM” 675, the state transitions to SP_DATA_WAIT 665.

Once the state machine transitions to SP_DATA_WAIT 665, the machine waits for the data valid indication from the eviction management logic. This state indicates that the snoop logic is waiting for new HITM data from the eviction logic. On receiving a data valid indication from eviction management logic 680, the state transitions to SNP_DONE state 645.

Once the state machine transitions to the SC_SNP state 625, the snoop management logic is given the responsibility of issuing a single snoop and is guaranteed that no such snoop is in progress in the eviction management logic. Once this is done, it sends the snoop to the appropriate core based on the presence vector. It also updates the coherence state and data buffers appropriately. Upon completing the single core snoop actions 685, the state transitions to SNP_DONE 645.

When the state transitions to MC_SNP 635 as a result of a snoop probe hit 630, then it first needs to optimize the number of snoops issued to the cores. It then continues to issue snoops to the core which are indicated by the issue vector. There could be some cores which have not yet returned snoop results. This information may be obtained by comparing the presence vector and the issue vector.

When the state transitions to MC_SNP 635 as a result of a LLC hit 630, then it issues snoops as indicated by presence vector. The ith bit of the presence vector is reset when the snoop result is observed from ith core. Now the data in the snoop management is valid and no new data is expected in the MC_SNP state 635. Once the presence vector is all zeroes 690, the state transitions to SNP_DONE 645.

When the state machine transitions to SNP_DONE 645, in this state the snooping actions are complete. The machine is waiting to return the snoop results and any new data to the external agent 695. Once the return is complete, the entry is de-allocated.

Since a snoop probe is guaranteed to not hit in both the multi-core evictions and a line in the inclusive shared cache. This is because evictions from the shared cache guarantee that the line is not present in the cache. Snoop probe of eviction management logic returns the presence vector, issue vector, SC bit, data valid bit and the coherence state of the line if it hits a valid eviction in flight. Using this information the snoop management logic will optimize the number of core snoops issues while preserving coherency and data consistency.

Between the snoop and eviction management logic, the defined states and transitions ensure that the responsibility of snooping the cores is cleanly partitioned. If a single core eviction is in progress, then snoop logic will not issue any new snoops but wait for the single core eviction to complete. If a multi core eviction is in progress, then snoop logic will copy the issue vector and issue snoops to only core which have not received eviction snoops. The data is also handed off in an efficient manner. If the current eviction is a multi core eviction, then no data wait states are defined since, we do not expect any new modified data.

Advantageously, the present embodiment allows for the processing of multi core evictions in a multi-core inclusive shared cache processor (eviction management logic) in the presence of external conflicts. Thus preserving coherence and data consistency. In addition, the embodiments allow for efficient handling of external snoop conflicts with multi-core/single-core eviction in flight (co-ordination between eviction management and snoop management using presence vector and issue vector).

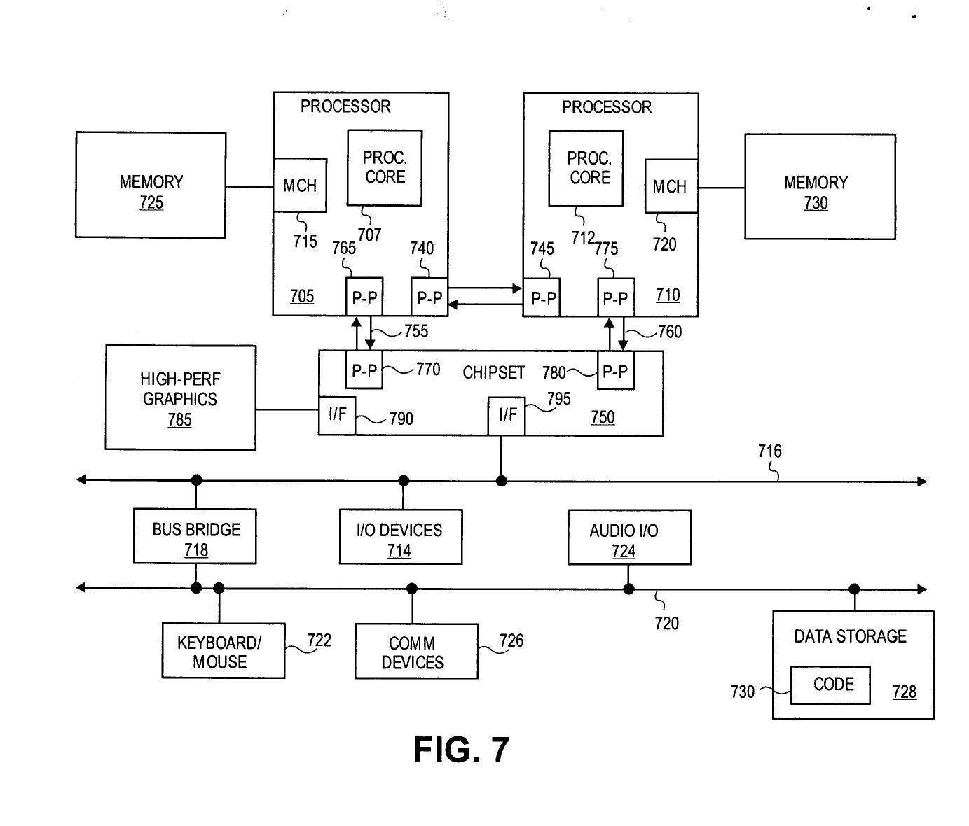

Referring now to FIG. 7, the system 700 includes processors supporting a lazy save and restore of registers. The system 700 generally shows a system where processors, memory, and input/output devices are interconnected by a number of point-to-point interfaces. The system 700 may also include several processors, of which only two, processors 705, 710 are shown for clarity. Each processor 705, 710 may each include a processor core 707, 712, respectively. Processors 705, 710 may each include a local memory controller hub (MCH) 715, 720 to connect with memory 725, 730. Processors 705, 710 may exchange data via a point-to-point interface 735 using point-to-point interface circuits 740, 745. Processors 705, 710 may each exchange data with a chipset 750 via individual point-to-point interfaces 755, 760 using point to point interface circuits 765, 770, 775, 780. Chipset 750 may also exchange data with a high-performance graphics circuit 785 via a high-performance graphics interface 790.

The chipset 750 may exchange data with a bus 716 via a bus interface 795. In either system, there may be various input/output I/O devices 714 on the bus 716, including in some embodiments low performance graphics controllers, video controllers, and networking controllers. Another bus bridge 718 may in some embodiments be used to permit data exchanges between bus 716 and bus 720. Bus 720 may in some embodiments be a small computer system interface (SCSI) bus, an integrated drive electronics (IDE) bus, or a universal serial bus (USB) bus. Additional I/O devices may be connected with bus 720. These may include keyboard and cursor control devices 722, including mouse, audio I/O 724, communications devices 726, including modems and network interfaces, and data storage devices 728. Software code 730 may be stored on data storage device 728. In some embodiments, data storage device 728 may be a fixed magnetic disk, a floppy disk drive, an optical disk drive, a magneto-optical disk drive, a magnetic tape, or non-volatile memory including flash memory.

Throughout the specification, the term, “instruction” is used generally to refer to instructions, macro-instructions, instruction bundles or any of a number of other mechanisms used to encode processor operations.

What is claimed is:

1. A processor comprising:
one or more cores; and
a scheduler in a bridge to seek eviction logic to process evictions to lines shared by the one or more cores.

2. The processor of claim 1 further comprising a distributed shared cache, wherein the distributed shared cache is distributed among the one or more cores.

3. The processor of claim 2 wherein the distributed shared cache is an inclusive, unified shared cache.

4. The processor of claim 3 wherein the inclusive shared cache stores presence vector information.

5. The processor of claim 4, wherein the presence vector includes information of evicted lines from the cores.

6. The processor of claim 5, wherein the eviction logic predicts which of the one or more cores to snoop based on the coherency state of the line being evicted and its core bit information.

7. The processor of claim 6 wherein the eviction logic process is complete when all back snoops have been sent to the core caches.

8. A method comprising:
detecting eviction from an inclusive shared cache;
passing state information of the eviction;
receiving the information; and
processing multicore evictions based on the information received.

9. The method of claim 8 further comprising determining if single or multi-core eviction.

10. The method of claim 9 wherein if determining single core eviction, issuing back snoop message to core interface.

11. The method of claim 10, further comprising waiting for snoop response to be observed by the core to which back snoop was issued.

12. The method of claim 11, further comprising receiving a HITM response from the core to obtain new data from the core.

13. The method of claim 11 further comprising receiving a CLEAN message from the core indicating data in the data buffer is most recent.

14. The method of claim 12 further comprising:
waiting for core to send modified data; and
transferring data to data buffer upon receiving the modified data.

15. The method of claim 14 further comprising writing the data to memory.

16. The method of claim 9, wherein if determining multi-core eviction, issuing back snoop message to all cores for which ith bit is set in the presence vector.

17. The method of claim 16 further comprising globally observing back snoop to the cores when the ith bit is reset.

18. A system comprising:
a processor including one or more cores, and a scheduler in a bridge to seek eviction logic to process evictions to lines shared by the one or more cores.
an external interconnect circuit to send audio data from the processor; and
an audio input/output device to receive the audio data.

19. The system of claim 18 wherein the bridge determines if it's a single or multi-core eviction.

20. The system of claim 19 wherein if single core eviction, issuing a back snoop message to the cores.
